(19) United States
(12) Patent Application Publication
(10) Pub. No.: US 2026/0156219 A1
(43) Pub. Date: Jun. 4, 2026

(54) IMAGE PROCESSING SYSTEM, IMAGE PROCESSING APPARATUS, AND IMAGE PROCESSING METHOD

(71) Applicant: Noriyuki SAI, Kanagawa (JP)

(72) Inventor: Noriyuki SAI, Kanagawa (JP)

(73) Assignee: Ricoh Company, Ltd., Ohta-ku, Tokyo (JP)

(21) Appl. No.: 19/391,280

(22) Filed: Nov. 17, 2025

(30) Foreign Application Priority Data
Nov. 29, 2024 (JP) 2024-208500

(51) Int. Cl. H04N 1/00

(52) U.S. Cl. CPC H04N 1/00811; H04N 1/00244

(57) ABSTRACT

An image processing system includes one or more image processing apparatuses and a server apparatus. Each image processing apparatus includes apparatus circuitry to cause a reading sensor to read a document and acquire sensor data read by the reading sensor, store in a first memory the sensor data and first identification information for identifying the sensor data in association, generate a first read image, and transmit the first read image to the server apparatus. The server apparatus includes server circuitry to receive the first read images, generate a set of image processing parameters for augmenting a first read image, the first read image being selected by a user terminal, and request the image processing apparatus to augment the selected first read image by using the set of image processing parameters and the first identification information corresponding to the selected first read image.

### CROSS-REFERENCE TO RELATED APPLICATIONS

This patent application is based on and claims priority pursuant to 35 U.S.C. § 119(a) to Japanese Patent Application No. 2024-208500, filed on Nov. 29, 2024, in the Japan Patent Office, the entire disclosure of which is hereby incorporated by reference herein.

### BACKGROUND

### Technical Field

The present disclosure relates to an image processing system, an image processing apparatus, and an image processing method.

### Related Art

The image reading apparatus performs image processing on data read by a reading sensor, converts the read data into an image file or a data file in a format such as a portable document format (PDF), and transmits the image file or the data file to a server or a user terminal.

In a case where artificial intelligence that receives an image read by the image reading apparatus is used, it is preferable to use the image that is actually read as learning data in order to enhance the performance of the artificial intelligence. Further, an image acquired by changing the read image may be added to the learning data, to expand the range that can be identified by the artificial intelligence. For example, the sensor data subjected to image processing may be prepared as the augmented image while changing the image processing parameters of the image reading apparatus in various ways, thus enhancing the determination accuracy of the artificial intelligence.

As a technique for obtaining a plurality of images, an optical character recognition (OCR) process is performed on read images read under a plurality of reading conditions in an image reading apparatus, and an image with high recognition accuracy is used. Additionally, in order to automatically generate image data having various layouts, an image is divided into three elements of character, geometric figure, and background, and different types of image processing are performed on the respective elements, to generate a large number of various images.

### SUMMARY

The present disclosure described herein provides an image processing system that includes one or more image processing apparatuses and a server apparatus communicably connected with the image processing apparatuses via a network. Each image processing apparatus includes apparatus circuitry to cause a reading sensor to read a document and acquire sensor data read by the reading sensor, store in a first memory the sensor data and first identification information for identifying the sensor data in association, generate a first read image by performing image processing on the sensor data using a predetermined image processing parameter, and transmit the first read image to the server apparatus. The server apparatus includes server circuitry to receive the first read images transmitted from the image processing apparatuses, generate a set of image processing parameters for augmenting a first read image, the first read image being selected by a user terminal from among the first read images received by the server circuitry, and request the image processing apparatus to augment the selected first read image by using the set of image processing parameters and the first identification information corresponding to the selected first read image. In response to reception of the request, the apparatus circuitry reads the sensor data corresponding to the first identification information in the request from the first memory, and generates a second read image by performing image processing on the sensor data using the set of image processing parameters in the request.

The present disclosure described herein provides an image processing apparatus that includes circuitry to, cause a reading sensor to read a document and acquire sensor data read by the reading sensor, store in a first memory the sensor data and first identification information for identifying the sensor data in association, generate a first read image by performing image processing on the sensor data using a predetermined image processing parameter, transmit the first read image to a server apparatus, and receive, from the server apparatus, a request for augmenting the first read image selected by a user terminal by using a set of image processing parameters and the first identification information corresponding to the selected first read image. In response to reception of the request, the circuitry reads the sensor data corresponding to the first identification information in the request from the first memory, and generates a second read image by performing image processing on the sensor data using the set of image processing parameters in the request.

The present disclosure described herein provides an image processing method including with a reading sensor, reading a document to acquire sensor data, storing in a first memory the sensor data and first identification information for identifying the sensor data in association, generating a first read image by performing image processing on the sensor data using a predetermined image processing parameter, transmitting the first read image to a server apparatus, receiving, from the server apparatus, a request for augmenting the first read image selected by a user terminal by using a set of image processing parameters and the first identification information corresponding to the selected first read image, wherein, in response to reception of the request, the circuitry reads the sensor data corresponding to the first identification information in the request from the first memory, and generates a second read image by performing image processing on the sensor data using the set of image processing parameters in the request.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an information processing system;

FIG. 2 is a sequence diagram illustrating a flow of an outline operation of an information processing system;

FIG. 3 is a diagram illustrating a hardware configuration of an image reading apparatus;

FIG. 4 is a diagram illustrating a hardware configuration of a learning data server;

FIG. 5 is a diagram illustrating a configuration of functional blocks of an image reading apparatus;

FIG. 6 is a diagram illustrating a sensor data database (DB);

FIG. 7 is a diagram illustrating a configuration of functional blocks of a learning data server;

FIG. 8 is a diagram illustrating a parameter condition setting screen;

FIG. 9 is a diagram illustrating an example of an augmented image processing parameter set;

FIG. 10 is a diagram illustrating a read image DB;

FIG. 11A and FIG. 11B are a diagram illustrating an augmented read image;

FIG. 12 is a sequence diagram illustrating a flow of a reading operation of an image reading apparatus;

FIG. 13 is a sequence diagram illustrating an operation of generating an augmented read image performed by an image reading apparatus; and

FIG. 14 is a sequence diagram illustrating an operation performed by a learning data server.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Descriptions are given below of an image processing system, an image processing apparatus, an image processing method, and a recording medium storing program for the image processing method, with reference to the drawings. The present disclosure, however, is not limited to the following embodiments, and constituent elements of the following embodiments include elements conceivable by those skilled in the art, substantially the same elements, and elements within so-called equivalent ranges. Furthermore, various omissions, substitutions, changes and combinations of the constituent elements can be made without departing from the gist of the following embodiments.

### Overall Configuration of Information Processing System

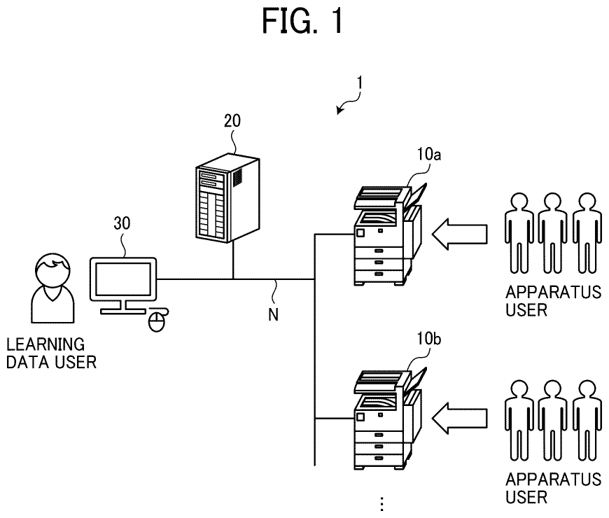

FIG. 1 is a diagram illustrating an overall configuration of an information processing system 1. The overall configuration of the information processing system 1 is described below with reference to FIG. 1.

The information processing system 1 augments data acquired by an information processing apparatus to generate learning data for use in machine learning. The information processing system 1 is, e.g., an image processing system for generating an image by augmenting a read image read by an image reading apparatus, which is an example of the information processing apparatus. As illustrated in FIG. 1, the information processing system 1 includes image reading apparatuses 10a and 10b, a learning data server 20, and a user terminal 30. The image reading apparatuses 10a and 10b, the learning data server 20, and the user terminal 30 communicate with one another via a network N. In the present disclosure, the learning data may be of any type as long as the learning data correspond to information acquired using a sensor included in the information processing apparatus or a sensor connected to the information processing apparatus. The sensor is a device that acquires sensor data having, for example, mechanical properties, electromagnetic properties, thermal properties, acoustic properties, or chemical properties. Information acquired by the sensor may be collectively referred to as sensor data. A plurality of information processing apparatuses each having a different type of sensor may be connected to the information processing system 1. In the following description, a case where an image reading apparatus such as the image reading apparatus 10a or 10b, which is an example of an information processing apparatus, acquires an image, which is an example of read data, by an image sensor, which is an example of a sensor, will be described.

The image reading apparatuses 10a and 10b are each an example of image processing apparatus that performs a reading operation on a document with a reading sensor such as an image sensor and generate a read image by performing image processing on the acquired sensor data. The image reading apparatuses 10a and 10b are each operated by a user. In the following description, the read image is an image acquired by performing image processing on sensor data. The image reading apparatuses 10a and 10b are, e.g., scanner devices or multifunction peripherals (MFPs) having, e.g., a scanner function. However, the image reading apparatus is not limited to the scanner device or the MFP, and may be any apparatus that acquires sensor data by an image sensor, and may be, e.g., a camera.

Although two image reading apparatuses 10a and 10b are illustrated in FIG. 1, the number of image reading apparatuses is not limited thereto, and may be one or three or more. Further, in a case of referring to any one of the image reading apparatuses 10a and 10b or collectively referring to the image reading apparatuses 10a and 10b, the image reading apparatuses 10a and 10b may be referred to as the “image reading apparatus 10”.

The learning data server 20 is a server apparatus that requests the image reading apparatus 10 to generate the read image to be used as the learning data by augmenting a particular read image based on a set of image processing parameters set by the user terminal 30, and accumulates the acquired read images as learning data used for machine learning. In the following description, generating new data by processing sensor data based on a parameter may be referred to as expansion or augmentation.

The user terminal 30 is an information terminal operated by a user to designate a read image to be augmented and set image processing parameters to be used for image processing. In the following, the user who operates the image reading apparatus 10 is referred to as an apparatus user, and the user who operates the user terminal 30 is referred to as a learning data user. However, the apparatus user and the learning data user may be the same. Further, the apparatus user of the image reading apparatus 10a and the apparatus user of the image reading apparatus 10b may be different or the same.

### Overview of Operation of Information Processing System

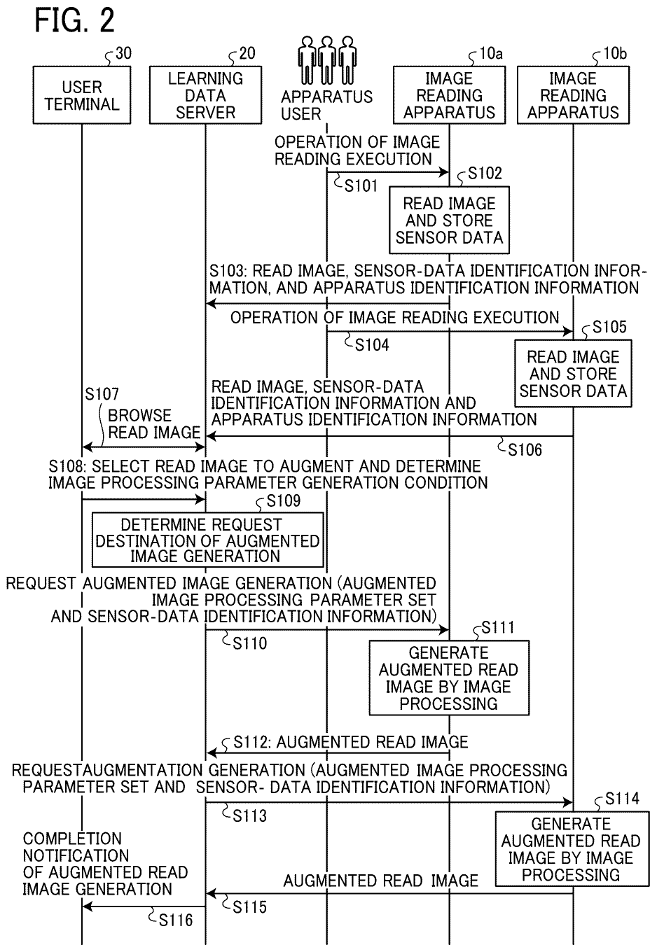

FIG. 2 is a sequence diagram illustrating an operation performed by the information processing system. A description is given below of an operation performed by the information processing system 1 with reference to FIG. 2.

### <Steps S101 and S102>

In step S101, the image reading apparatus 10a receives an instruction to perform image reading on a desired document from the apparatus user. In step S102, the image reading apparatus 10a reads the document with the reading sensor, performs image processing on the acquired sensor data to generate a read image, and stores the sensor data in an internal storage device.

### <Step S103>

In step S103, the image reading apparatus 10a transmits the generated read image, sensor-data identification information (e.g., a file name of the sensor data) for identifying the sensor data acquired from the reading sensor, and device identification information (e.g., a device name, an internet protocol (IP) address, or a media access control (MAC) address of the image reading apparatus 10a) for identifying the image reading apparatus 10a to the learning data server 20 via the network N. The learning data server 20 stores the received read image in a memory.

### <Steps S104 and S105>

In step S104, the image reading apparatus 10b receives an instruction to perform image reading on a desired document from the apparatus user. In step S105, the image reading apparatus 10b reads the document with the reading sensor, performs image processing on the acquired sensor data to generate a read image, and stores the sensor data in an internal storage device.

### <Step S106>

In step S106, the image reading apparatus 10b transmits the generated read image, sensor-data identification information (e.g., a file name of the sensor data) for identifying the sensor data acquired from the reading sensor, and device identification information (e.g., a device name, an internet protocol (IP) address, or a media access control (MAC) address of the image reading apparatus 10b) for identifying the image reading apparatus 10b to the learning data server 20 via the network N. The learning data server 20 stores the received read image in the memory.

### <Step S107>

In step S107, the user terminal 30 displays the read images stored in the learning data server 20 to allow the learning data user to browse the read images stored in the learning data server 20.

### <Step S108>

In step S108, the user terminal 30 receives a particular read image to be augmented that is selected by the learning data user, and a condition for generating an image processing parameter used for augmenting that is input by the learning data user. Thus, augmentation is performed on the desired read image. The selection result of the read image and the image-processing parameter generation condition are transmitted from the user terminal 30 to the learning data server 20.

### <Step S109>

In step S109, the learning data server 20 determines a generation request destination to which the request for augmenting the read image to generate an augmented read image is transmitted, from the read image indicated by the received selection result. In this example, the generation request destination is the image reading apparatus 10 which is a generation source of the read image indicated by the selection result.

### <Step S110>

In step S110, the learning data server 20 transmits an augmentation generation request including the augmented image-processing parameter set generated from the received image-processing parameter generation condition and the sensor-data identification information corresponding to the read image to be augmented to the image reading apparatus 10a that is the generation request destination.

### <Steps S111 and S112>

In step S111, the image reading apparatus 10a generates an augmented read image by performing image processing on the read image using the augmented image processing parameter set included in the received augmentation generation request. In step S112, the image reading apparatus 10a transmits the augmented read image to the learning data server 20.

### <Step S113>

In step S113, the learning data server 20 transmits an augmentation generation request including the augmented image processing parameter set generated from the received image-processing parameter generation condition and the sensor-data identification information corresponding to the read image to be augmented to the image reading apparatus 10b that is the generation request destination.

### <Steps S114 and S115>

In step S114, the image reading apparatus 10b generates an augmented read image by performing image processing on the sensor data using the augmented image processing parameter set included in the received augmentation generation request. In step S115, the image reading apparatus 10b transmits the augmented read image to the learning data server 20.

### <Step S116>

In step S116, when the learning data server 20 receives the augmented read image, the learning data server 20 transmits a generation completion notice of the augmented read image to the user terminal 30.

### Hardware Configuration of Image Reading Apparatus

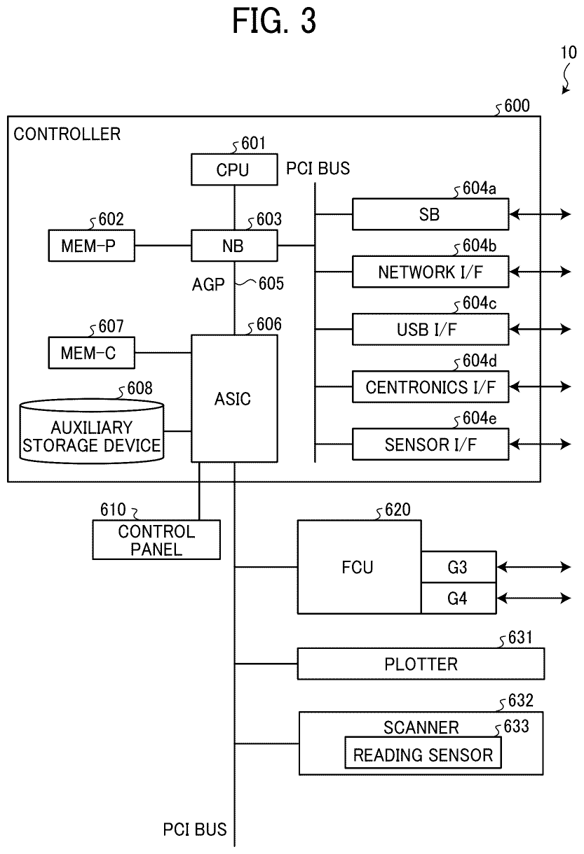

FIG. 3 is a diagram illustrating a hardware configuration of the image reading apparatus. A description is given of a hardware configuration of the image reading apparatus 10 with reference to FIG. 3. In the following description, the image reading apparatus 10 is an MFP.

As illustrated in FIG. 3, the image reading apparatus 10 includes a controller 600, a control panel 610, a facsimile control unit (FCU) 620, a plotter 631, and a scanner 632, which are connected to each other via a peripheral component interface (PCI) bus. The scanner 632 includes the reading sensor 633.

The controller 600 controls the overall operation of the image reading apparatus 10, including drawing, communication, and input through the control panel 610.

The control panel 610 is, e.g., a touch panel, and is a device that receives an input to the controller 600 (input function) and displays, e.g., a state of the image reading apparatus 10 (display function). The control panel 610 is directly connected to an application-specific integrated circuit (ASIC) 606 described below.

The FCU 620 is a device that implements a facsimile function, and is connected to the ASIC 606 by, e.g., the PCI bus.

The plotter 631 is a device that implements a printing function. The plotter 631 is connected to the ASIC 606 by, e.g., the PCI bus.

The scanner 632 is a device that implements a scanner function. The scanner 632 is connected to the ASIC 606 via, e.g., the PCI bus. The scanner 632 includes the reading sensor 633 of the image reading apparatus 10 described above.

As illustrated in FIG. 3, the controller 600 includes a central processing unit (CPU) 601, a system memory (MEM-P) 602, a north bridge (NB) 603, a south bridge (SB) 604a, a network interface (I/F) 604b, a universal serial bus (USB) I/F 604c, a centronics I/F 604d, a sensor I/F 604e, an ASIC 606, a local memory (MEM-C) 607, and an auxiliary storage device 608.

The CPU 601 is an arithmetic device that performs overall control of the image reading apparatus 10. The CPU 601 is connected to a chipset including the system memory 602, the NB 603, and the SB 604a, and is connected to other devices via the chipset.

The system memory 602 is a memory for, e.g., storing programs and data, loading programs and data, and loading drawing data for a printer. The system memory includes a read-only memory (ROM) and a random-access memory (RAM). The ROM is a read-only memory used to store programs and data. The RAM is write-and-read enabled memory used for executing programs and data, as well as for functions such as drawing memory for a printer.

The NB 603 is a bridge that connects the CPU 601, the system memory 602, the SB 604a, and an accelerated graphics port (AGP) bus 605. The NB 603 includes a memory controller that controls the reading and writing from and to the system memory 602, a PCI master, and an AGP target.

The SB 604a is a bridge that electrically connects the NB 603 to PCI devices and peripheral devices. The SB 604a is connected to the NB 603 via the PCI bus, and the PCI bus is connected to, e.g., a network I/F 604b, a USB I/F 604c, a centronics I/F 604d, and a sensor I/F 604e.

The AGP bus 605 is a bus interface for a graphics accelerator card, which has been proposed to accelerate graphics processing. The AGP bus 605 directly accesses the system memory 602 with high throughput to accelerate the graphics accelerator card.

The ASIC 606 is an integrated circuit (IC) dedicated to image processing and includes hardware elements for image processing. The ASIC 606 serves as a bridge that electrically connects the AGP bus 605, the PCI buses, the storage device 608, and the local memory 607. The ASIC 606 includes a PCI target, an AGP master, an arbiter (ARB) as a central processor of the ASIC 606, a memory controller that controls the local memory 607, multiple direct memory access controllers (DMACs), and a PCI unit. For example, the DMACs convert the coordinates of image data with a hardware logic to rotate an image based on the image data. The PCI unit transfers data between the plotter 631 and the scanner 632 via the PCI bus. For example, the ASIC 606, the plotter 631, and the scanner 632 are connected to the FCU 620 via the PCI bus.

The local memory 607 is a local memory used as a buffer for an image to be copied or a buffer for coding.

The auxiliary storage device 608 is a storage device such as a hard disk drive (HDD), a solid-state drive (SSD), a secure digital (SD) card, or a flash memory that stores image data, programs, font data, and forms.

The hardware configuration of the image reading apparatus 10 illustrated in FIG. 3 is an example, and the image reading apparatus 10 does not need to include all devices, and may include other devices. For example, the image reading apparatus 10 may include, e.g., an automatic document feeder (ADF).

### Hardware Configuration of Learning Data Server

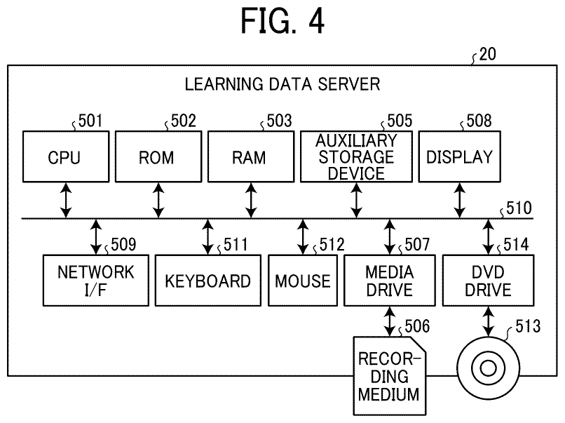

FIG. 4 is a diagram illustrating a hardware configuration of the learning data server.

A description is given below of the hardware configuration of the learning data server with reference to FIG. 4.

As illustrated in FIG. 4, the learning data server 20 includes a CPU 501, a ROM 502, a RAM 503, an auxiliary storage device 505, a media drive 507, a display 508, a network I/F 509, a keyboard 511, a mouse 512, and a digital versatile disc (DVD) drive 514.

The CPU 501 is an arithmetic device that controls the operation of the entire learning data server 20. The ROM 502 is a non-volatile storage device that stores a program such as an initial program loader (IPL) that is executed first by the CPU 501. The RAM 503 is a volatile storage device used as a work area for the CPU 501.

The auxiliary storage device 505 is a nonvolatile storage device that stores various data such as a program. The auxiliary storage device 505 is, e.g., an HDD or an SSD.

The media drive 507 controls the reading of data from, or the writing (storing) of data to (in), a recording medium 506 such as a flash memory.

The display 508 is, e.g., a liquid crystal display (LCD), an organic electro-luminescence (EL) display that displays various types of information, such as a cursor, a menu, a window, text, or an image.

The network I/F 509 is an interface for performing data communication via the network N. The network I/F 509 is, e.g., a network interface card (NIC) to establish communications in compliance with Transmission Control Protocol (TCP)/Internet protocol (IP). The network I/F 509 may be a communication interface having a wireless communication function based on a standard such as Wi-Fi®.

The keyboard 511 is an example of an input device provided with multiple keys used for inputting, e.g., characters, numerical values, and various instructions. The mouse 512 is a type of input device that, e.g., selects and executes various instructions, selects a processing target, and moves a cursor.

The DVD-RW drive 514 controls the reading of various data from, or the writing of various data to, a DVD 513, which is an example of a removable storage medium. The DVD 513 is, e.g., a digital versatile disc-rewritable (DVD-RW), a digital versatile disc-recordable (DVD-R), a compact disc-rewritable (CD-RW), or a compact disc-recordable (CD-R).

The above-described CPU 501, ROM 502, RAM 503, auxiliary storage device 505, media drive 507, display 508, network I/F 509, keyboard 511, mouse 512, and DVD drive 514 are connected to each other so as to communicate with each other via a bus line 510 such as an address bus or a data bus.

The hardware configuration of the learning data server 20 illustrated in FIG. 4 is an example, and the learning data server 20 does not need to include all the constituent devices, and may include other constituent devices.

The hardware configuration of the user terminal 30 is also similar to the configuration illustrated in FIG. 4.

### Configuration and Operation of Functional Blocks of Image Reading Apparatus

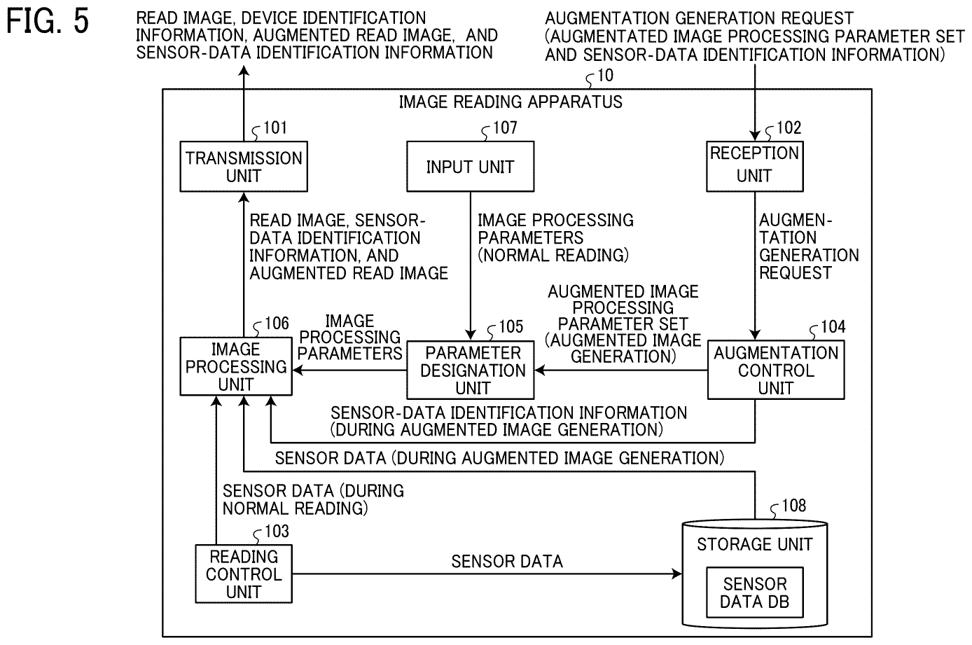

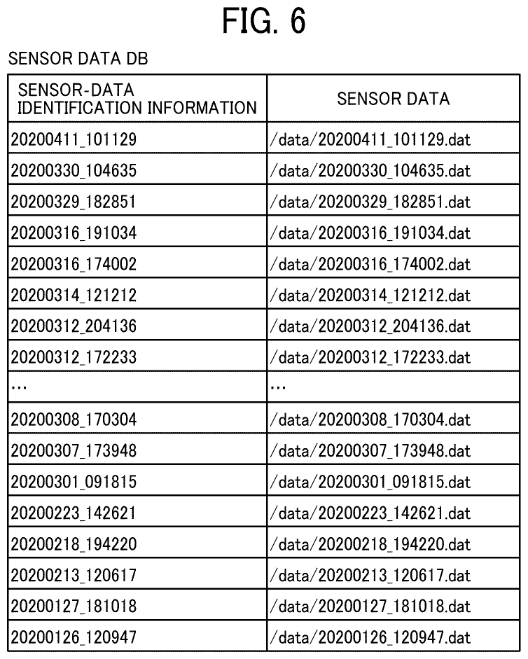

FIG. 5 is a diagram illustrating a configuration of functional blocks of the image reading apparatus 10. FIG. 6 is a diagram illustrating a sensor data DB. A description is given of the configuration and operation of the functional blocks of the image reading apparatus 10 with reference to FIG. 5 and FIG. 6.

As illustrated in FIG. 5, the image reading apparatus 10 includes a transmission unit 101, a reception unit 102 (request reception unit), a reading control unit 103, an augmentation control unit 104, a parameter designation unit 105, an image processing unit 106, an input unit 107, and a storage unit 108 (first storage unit).

The transmission unit 101 is a functional unit that transmits the read image generated by the image processing unit 106, the sensor-data identification information for identifying the sensor data acquired from the reading sensor 633, and the device identification information (second identification information) for identifying the image reading apparatus 10 to the learning data server 20 via the network I/F 604b. The transmission unit 101 transmits the augmented read image generated by the image processing unit 106 to the learning data server 20 via the network I/F 604b. As described below, when the sensor data includes the sensor-data identification information, the transmission unit 101 may omit the transmission of the sensor-data identification information.

The reception unit 102 is a functional unit that receives, from the learning data server 20 via the network I/F 604b, an augmentation generation request including an augmented image processing parameter set and sensor-data identification information corresponding to a read image to be augmented.

The reading control unit 103 is a functional unit that controls a reading operation. The reading control unit 103 is an example of an acquisition unit. Specifically, the reading control unit 103 causes the reading sensor 633 to perform a reading operation on the document, acquires sensor data from the reading sensor 633, and outputs the sensor data to the image processing unit 106. The reading control unit 103 associates the acquired sensor data with sensor-data identification information (first identification information) for identifying the sensor data, and stores the sensor data and the sensor-data identification information in the sensor data DB illustrated in FIG. 6 in the storage unit 108.

As illustrated in FIG. 6, the sensor data DB is a database that manages sensor data and sensor-data identification information (e.g., a file name of the sensor data) for identifying the sensor data in association with each other. The sensor data managed by the sensor data DB may be a path to a particular area in the storage unit 108 in which the sensor data is stored. The method of associating the sensor data with the sensor-data identification information is not limited to this example of using the DB. For example, the sensor data may be associated with the sensor-data identification information by associating information such as the file name or the generation date and time of the sensor data as metadata to the sensor data. In other words, the sensor data may include the sensor-data identification information as metadata.

The augmentation control unit 104 is a functional unit that controls a process related to augmenting in response to the augmentation generation request received by the reception unit 102. Specifically, the augmentation control unit 104 outputs the augmented image processing parameter set included in the augmentation generation request to the parameter designation unit 105. The augmentation control unit 104 notifies the image processing unit 106 of the sensor-data identification information included in the augmentation generation request.

The parameter designation unit 105 is a functional unit that designates (notifies) an image processing parameter used for image processing by the image processing unit 106. Specifically, in a regular reading operation, the parameter designation unit 105 notifies the image processing unit 106 of the image processing parameters used in the regular reading operation. When generating the augmented read image, the parameter designation unit 105 notifies the image processing unit 106 of the augmented image processing parameter set that is received from the augmentation control unit 104.

The image processing unit 106 is an example of a processing unit. The image processing unit 106 is a functional unit that performs image processing, which is an example of information processing, on the sensor data using an image processing parameter, which is an example of a parameter to generate a read image. Specifically, in a regular reading operation, the image processing unit 106 performs image processing on the sensor data received from the reading control unit 103 using the image processing parameters used in the regular reading operation designated by the parameter designation unit 105 to generate a read image (first read image). The read image is an example of data acquired by reading, and the first read image may be expressed as first data. The image processing unit 106 transmits the generated read image and the sensor-data identification information of the sensor data used to obtain the read image to the transmission unit 101. The image processing unit 106 may generate a read image to which the sensor-data identification information is added as metadata. For example, the file name of the read image may be set to be the same as the file name of the sensor data. Accordingly, the process of transmitting the sensor-data identification information to the transmission unit 101 may be omitted. When the augmented read image is generated, the image processing unit 106 reads, from the sensor data DB of the storage unit 108, the sensor data indicated by the sensor-data identification information received from the augmentation control unit 104, performs image processing on the sensor data using the augmented image processing parameter set designated by the parameter designation unit 105, and generates the augmented read image (second read image). The augmented read image is an example of augmented data, and the second read image may be expressed as second data. The image processing unit 106 transmits the generated augmented read image to the transmission unit 101.

The input unit 107 is a functional unit that receives an operation input from the apparatus user. For example, the input unit 107 receives an operation of designating an image processing parameter used for image processing from the apparatus user in a regular reading operation. The input unit 107 is implemented by the control panel 610 illustrated in FIG. 3.

The storage unit 108 is a functional unit that stores, e.g., the sensor data DB. The storage unit 108 is implemented by the auxiliary storage device 608 illustrated in FIG. 3.

The transmission unit 101, the reception unit 102, the reading control unit 103, the augmentation control unit 104, the parameter designation unit 105, and the image processing unit 106 described above are implemented by, e.g., the CPU 601 illustrated in FIG. 3 executing a program. The transmission unit 101, the reception unit 102, the reading control unit 103, the augmentation control unit 104, the parameter designation unit 105, and the image processing unit 106 may be implemented by hardware such as an integrated circuit, or may be implemented by a combination of software and hardware.

The functional units of the image reading apparatus 10 illustrated in FIG. 5 are conceptual representations of functions, and the configuration is not limited to the functional units of FIG. 5. For example, a plurality of functional units illustrated as independent functional units in the image reading apparatus 10 illustrated in FIG. 5 may be configured as one functional unit. On the other hand, in the image reading apparatus 10 illustrated in FIG. 5, a function of one functional unit may be divided into a plurality of functions, and the functional unit may be configured as a plurality of functional units. Further, the functional units of the image reading apparatus 10 do not need to be configured as distinct software modules as the blocks illustrated in FIG. 5, and all functions of the functional units may be implemented by executing a program in the image reading apparatus 10.

### Configuration and Operation of Functional Block of Learning Data Server

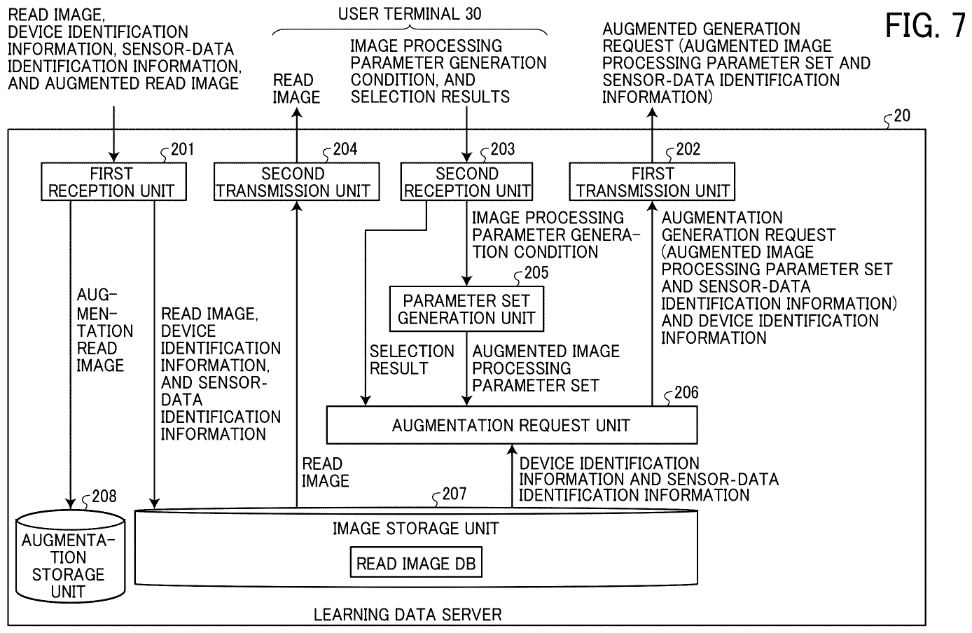

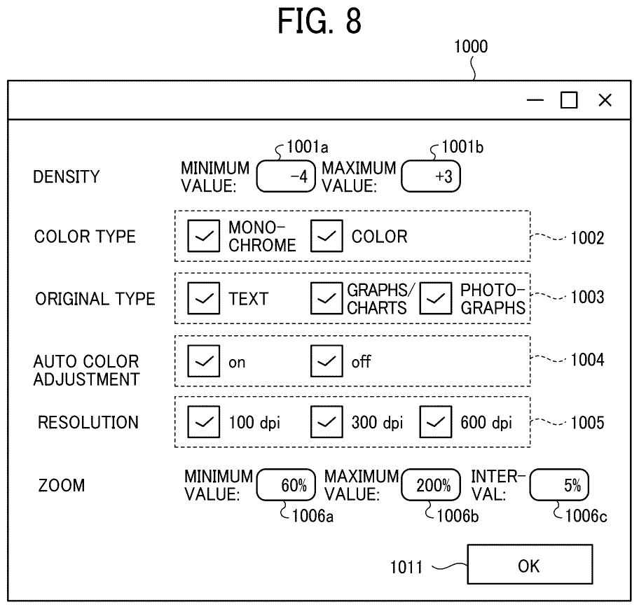

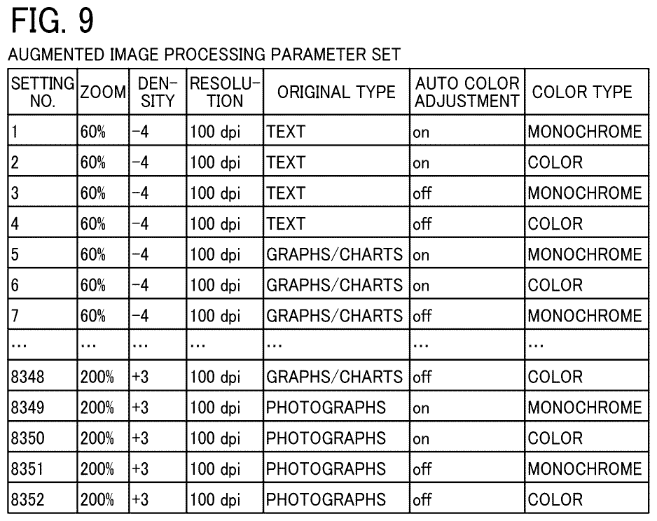

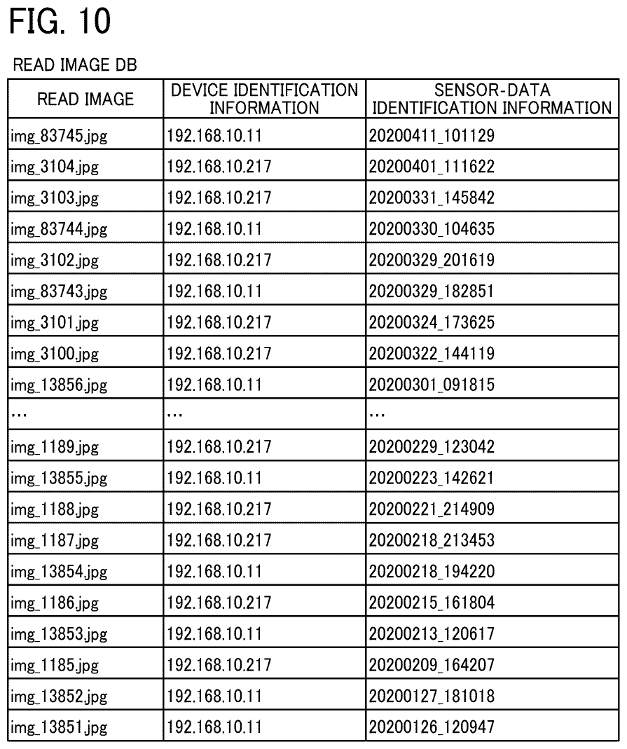

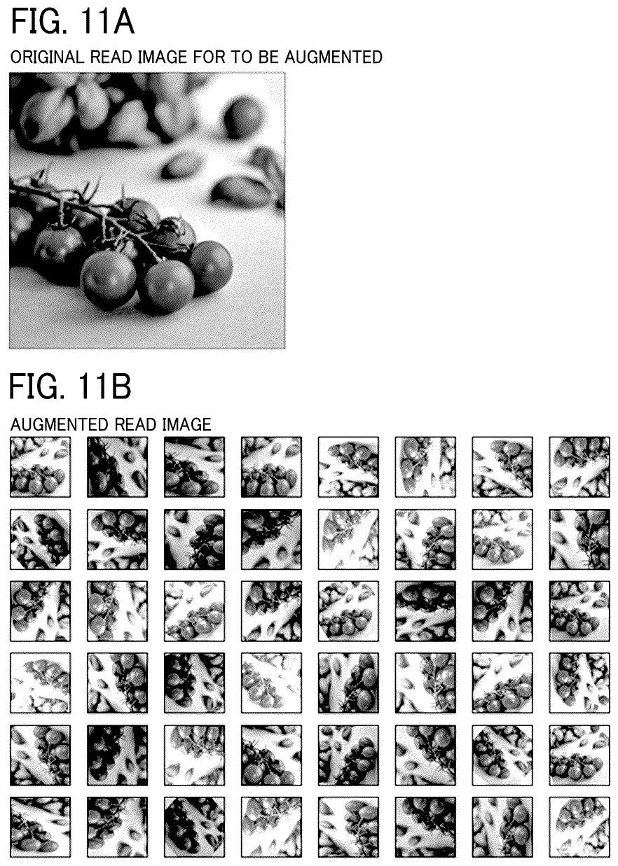

FIG. 7 is a diagram illustrating a configuration of functional blocks of a learning data server 20. FIG. 8 is a diagram illustrating an example of a parameter condition setting screen. FIG. 9 is a diagram illustrating an example of an augmented image processing parameter set. FIG. 10 is a diagram illustrating a read image DB. FIG. 11A and FIG. 11B are a diagram illustrating an augmented read image. The configuration and operation of the functional blocks of the learning data server 20 will be described with reference to FIGS. 7 to 11.

As illustrated in FIG. 7, the learning data server 20 includes a first reception unit 201 (reception unit), a first transmission unit 202, a second reception unit 203, a second transmission unit 204, a parameter set generation unit 205 (generation unit), an augmentation request unit 206 (request unit), an image storage unit 207, and an augmentation storage unit 208 (second storage unit).

The first reception unit 201 is a functional unit that receives, from the image reading apparatus 10 via the network I/F 509, a read image generated by the image reading apparatus 10, sensor-data identification information of the sensor data corresponding to the read image, and the device identification information for identifying the image reading apparatus 10. The first reception unit 201 stores the received read image, the sensor-data identification information, and the device identification information in the read image DB in the image storage unit 207, which is illustrated in FIG. 10, in association with each other.

As illustrated in FIG. 10, the read image DB is a database that manages a read image, sensor-data identification information for identifying sensor data used to generate the read image, and device identification information for identifying the image reading apparatus 10 that has generated the read image in association with one another. The read image may be managed by the read image DB as a path to a storage area of the image storage unit 207 in which the read image is stored.

The first reception unit 201 receives the augmented read image generated by the image reading apparatus 10 from the image reading apparatus 10 via the network I/F 509. The first reception unit 201 stores the received augmented read image in the augmentation storage unit 208.

The first transmission unit 202 is a functional unit that transmits the augmentation generation request generated by the augmentation request unit 206 to the image reading apparatus 10 via the network I/F 509. The first transmission unit 202 specifies the image reading apparatus 10 to which the augmentation generation request is transmitted, based on the device identification information received from the augmentation request unit 206, and transmits the augmentation generation request to the specified image reading apparatus 10. The augmentation generation request includes the augmented image processing parameter set, which is generated by the parameter set generation unit 205, and the sensor-data identification information.

The second reception unit 203 is a functional unit that receives the selection result of the read image to be augmented and the image-processing parameter generation condition used for augmenting from the user terminal 30 via the network I/F 509. The second reception unit 203 outputs the received selection result to the augmentation request unit 206, and outputs the image-processing parameter generation condition to the parameter set generation unit 205.

A description is given of a parameter condition setting screen 1000 for setting the image-processing parameter generation condition in the user terminal 30 with reference to FIG. 8. As illustrated in FIG. 8, the parameter condition setting screen 1000 includes a minimum density setting area 1001a, a maximum density setting area 1001b, a color type setting area 1002, a document type setting area 1003, an automatic color adjustment setting area 1004, a resolution setting area 1005, a minimum zoom setting area 1006a, a maximum zoom setting area 1006b, a zoom interval setting area 1006c, and an OK button 1011, each of which receives a user input.

The minimum density setting area 1001a is an area for setting a minimum value of density in image processing. The maximum density setting area 1001b is an area for setting a maximum value of density in image processing.

The color type setting area 1002 is an area for setting a color type (monochrome, color) in image processing. The document type setting area 1003 is an area for setting a document type (text, figure, photograph). The automatic color adjustment setting area 1004 is an area for setting ON/OFF of automatic color adjustment in image processing. The resolution setting area 1005 is an area for setting a resolution (e.g., 100 [dpi], 300 [dpi], or 600 [dpi]) in image processing.

The minimum zoom setting area 1006a is an area for setting a minimum zoom value in image processing. The maximum zoom setting area 1006b is an area for setting a maximum zoom value in image processing. The zoom interval setting area 1006c is an area for setting a zoom scale in image processing.

The OK button 1011 is a button for generating the contents set in the respective setting areas as the image-processing parameter generation condition. When the learning data user presses the OK button 1011, the user terminal 30 generates the contents set in the respective setting areas as the image-processing parameter generation condition and transmits the created condition to the learning data server 20.

The setting contents illustrated in the parameter condition setting screen 1000 illustrated in FIG. 7 are examples, and the image-processing parameter generation condition may include some of these contents or may include contents other than these contents.

The second transmission unit 204 reads the read image from the image storage unit 207 in response to a browsing operation from the user terminal 30, and transmits the read image to the user terminal 30 via the network I/F 509.

The parameter set generation unit 205 is a functional unit that generates an augmented image processing parameter set based on the image-processing parameter generation condition received from the second transmission unit 204. For example, the parameter set generation unit 205 generates the augmented image processing parameter set by combining the image processing parameters indicated by the image-processing parameter generation condition. The parameter set generation unit 205 outputs the generated augmented image processing parameter set to the augmentation request unit 206. The augmented image processing parameter set illustrated as an example illustrated in FIG. 9 is a set of image processing parameters for augmenting generated by the parameter set generation unit 205 by combining the image processing parameters set on the parameter condition setting screen 1000 illustrated in FIG. 8.

The augmentation request unit 206 is a functional unit that generates an augmentation generation request for requesting the image reading apparatus 10 to augment a predetermined read image. Specifically, the augmentation request unit 206 refers to the read image DB of the image storage unit 207, and reads the device identification information and the sensor-data identification information corresponding to the read image indicated by the selection result received from the second reception unit 203. The device identification information and the sensor-data identification information may be read out from the read image DB, for example, using the file name of the read image indicated by the selection result. The augmentation request unit 206 generates an augmentation generation request including the read sensor-data identification information and the augmented image processing parameter set received from the parameter set generation unit 205. The augmentation request unit 206 outputs the read device identification information and the generated augmentation generation request to the first transmission unit 202.

The image storage unit 207 is a functional unit that includes, e.g., a read image DB. The image storage unit 207 is implemented by the auxiliary storage device 505 illustrated in FIG. 4.

The augmentation storage unit 208 is a functional unit that stores the augmented read image generated by the image reading apparatus 10 and received by the first reception unit 201. The augmentation storage unit 208 is implemented by the auxiliary storage device 505 illustrated in FIG. 4. The augmentation storage unit 208 and the image storage unit 207 may be implemented by different storage devices, instead of the same storage device (in this description, the auxiliary storage device 505).

The augmented read images received by the first reception unit 201 and stored in the augmentation storage unit 208 are illustrated in FIG. 11A and FIG. 11B. FIG. 11A illustrates a read image designated (selected) as an augmentation target. FIG. 11B illustrates examples of augmented read image each generated through image processing based on the augmented image processing parameter set that indicates, e.g., size enlargement, size reduction, brightness, or rotation.

The augmented read image stored in the augmentation storage unit 208 as described above is used as learning data for machine learning.

The first reception unit 201, the first transmission unit 202, the second reception unit 203, the second transmission unit 204, the parameter set generation unit 205, and the augmentation request unit 206 described above are implemented by, e.g., the CPU 501 illustrated in FIG. 4 executing a program. The first reception unit 201, the first transmission unit 202, the second reception unit 203, the second transmission unit 204, the parameter set generation unit 205, and the augmentation request unit 206 may be implemented by hardware such as an integrated circuit, or may be implemented by a combination of software and hardware.

The functional units of the learning data server 20 illustrated in FIG. 7 are conceptual representations of functions, and the configuration is not limited to the example illustrated in FIG. 7. For example, a plurality of functional units illustrated as independent functional units in the learning data server 20 illustrated in FIG. 7 may be configured as one functional unit. On the other hand, the function of one functional unit in the learning data server 20 illustrated in FIG. 7 may be divided into a plurality of functions and configured as a plurality of functional units. Further, each functional unit of the learning data server 20 does not need to be configured as a distinct software module as the block illustrated in FIG. 7, and the function of each functional unit may be implemented by executing a program in the learning data server 20.

### Reading Operation of Image Reading Apparatus

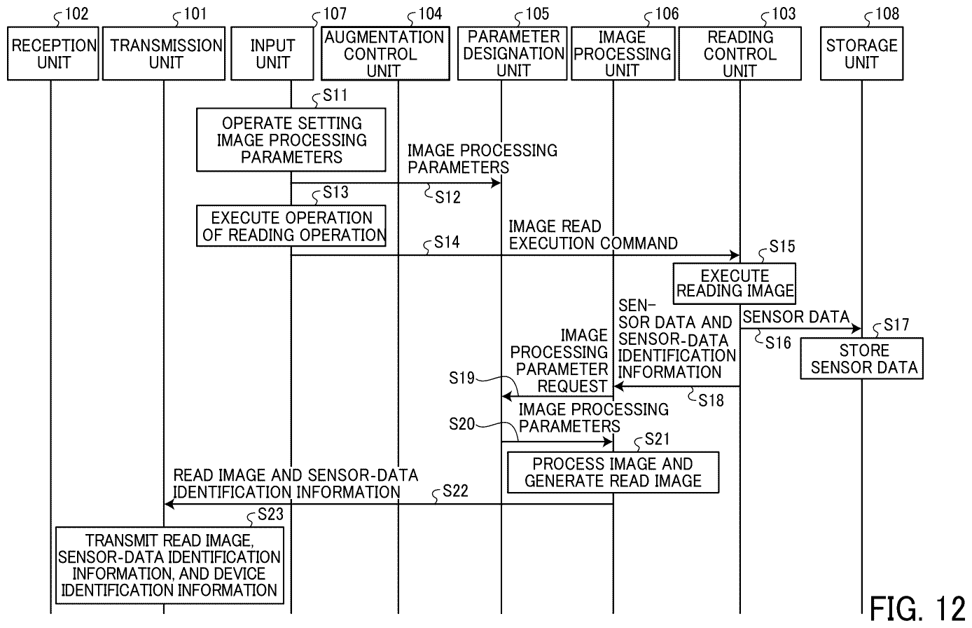

FIG. 12 is a sequence diagram illustrating a reading operation performed by the image reading apparatus. A description is given of the reading operation of the image reading apparatus 10 with reference to FIG. 12.

### <Steps S11 and S12>

In step S11, the input unit 107 receives, from the apparatus user, an operation of setting the image processing parameters. In step S12, the input unit 107 transmits the image processing parameter for which the setting operation has been performed to the parameter designation unit 105.

### <Steps S13 and S14>

In step S13, the input unit 107 receives, from the apparatus user, an instruction to execute the reading operation. In step S14, the input unit 107 transmits an image reading execution command for instructing execution of the reading operation to the reading control unit 103.

### <Steps S15 to S17>

In step S15, the reading control unit 103 causes the reading sensor 633 to perform a reading operation on the document in accordance with the image reading execution command, and acquires sensor data from the reading sensor 633. In steps S16 and S17, the reading control unit 103 stores the acquired sensor data and the sensor-data identification information for identifying the sensor data in the sensor data DB in the storage unit 108 in association with each other.

### <Step S18>

In step S18, the reading control unit 103 outputs the sensor data and the sensor-data identification information for identifying the sensor data to the image processing unit 106.

### <Step S19>

In step S19, in response to receiving the sensor data and the sensor-data identification information, the image processing unit 106 requests the parameter designation unit 105 to transmit the image processing parameter.

### <Step S20>

In step S19, the parameter designation unit 105 outputs the image processing parameter to the image processing unit 106 in response to a request from the image processing unit 106.

### <Step S21>

In step S21, the image processing unit 106 performs image processing on the sensor data received from the reading control unit 103 using the image processing parameters received from the parameter designation unit 105, and generates a read image. The image processing unit 106 may count the number of times the image processing parameter is used for image processing for each image processing parameter and store the counted number in the storage unit 108.

### <Step S22>

In step S22, the image processing unit 106 transmits the generated read image and the sensor-data identification information of the sensor data used to obtain the read image to the transmission unit 101.

### <Step S23>

In step S23, the transmission unit 101 transmits the read image generated by the image processing unit 106, the sensor-data identification information for identifying the sensor data acquired from the reading sensor 633, and the device identification information for identifying the image reading apparatus 10 to the learning data server 20 via the network I/F 604b.

### Generation Operation of Augmented Read Image of Image Reading Apparatus

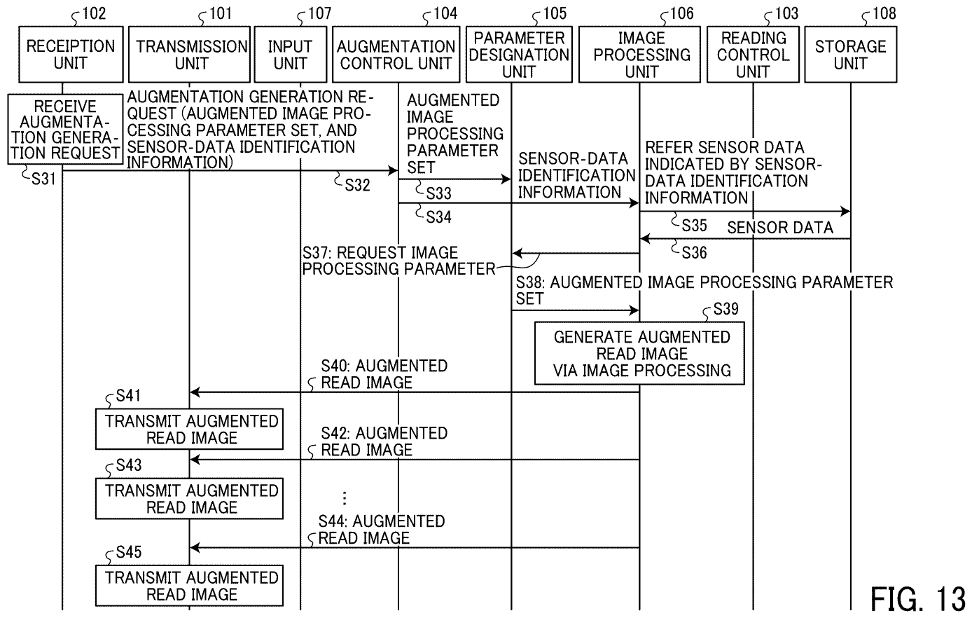

FIG. 13 is a sequence diagram illustrating an operation of generating an augmented read image performed by the image reading apparatus 10. A description is given of the operation of generating the augmented read image performed by the image reading apparatus 10 with reference to FIG. 13.

### <Steps S31 and S32>

In step S31, the reception unit 102 receives, from the learning data server 20 via the network I/F 604b, an augmentation generation request including an augmented image processing parameter set and the sensor-data identification information corresponding to the read image to be augmented. In step S32, the reception unit 102 outputs the augmentation generation request to the augmentation control unit 104.

### <Steps S33 and S34>

In step S33, the augmentation control unit 104 outputs the augmented image processing parameter set included in the augmentation generation request to the parameter designation unit 105. In step S34, the augmentation control unit 104 transmits the sensor-data identification information included in the augmentation generation request to the image processing unit 106.

### <Steps S35 and S36>

In step S35, the image processing unit 106 refers to the sensor data DB in the storage unit 108. In step S36, the image processing unit 106 reads, from the sensor data DB, the sensor data indicated by the sensor-data identification information received from the augmentation control unit 104.

### <Step S37>

In step S37, the image processing unit 106 requests the parameter designation unit 105 to transmit the image processing parameter.

### <Step S38>

In step S38, the parameter designation unit 105 notifies the image processing unit 106 of the augmented image processing parameter set, which is received from the augmentation control unit 104 in response to the request.

### <Step S39>

In step S39, the image processing unit 106 performs image processing on the sensor data read from the sensor data DB in the storage unit 108 using the augmented image processing parameter set received from the parameter designation unit 105, and generates an augmented read image.

In a case where the counted number of the image processing parameter used for image processing is stored in the storage unit 108 for each image processing parameter as described above referring to step S21 of FIG. 12, the image processing unit 106 may determine the number of augmented read images to be generated using the image processing parameter, according to the counted number stored in the storage unit 108 corresponding to the image processing parameter included in the augmented image processing parameter set. In this case, the image processing unit 106 may add noise similar to the noise generated in the reading operation by the reading sensor 633 to the sensor data, and then generate the determined number of augmented read images. Accordingly, the number of augmented read images increases for the image processing parameter frequently used by the apparatus user.

### <Steps S40 to S45>

In step S40, the image processing unit 106 transmits the augmented read images, which are sequentially generated, to the transmission unit 101 using the augmented image processing parameter set. In step S41, the transmission unit 101 transmits the augmented read images to the learning data server 20 via the network I/F 604b. In step S42, the image processing unit 106 transmits the augmented read images, which are sequentially generated, to the transmission unit 101 using the augmented image processing parameter set. In step S43, the transmission unit 101 transmits the augmented read images to the learning data server 20 via the network I/F 604b. In step S44, the image processing unit 106 transmits the augmented read images, which are sequentially generated, to the transmission unit 101 using the augmented image processing parameter set. In step S45, the transmission unit 101 transmits the augmented read images to the learning data server 20 via the network I/F 604b.

### Operation of Learning Data Server

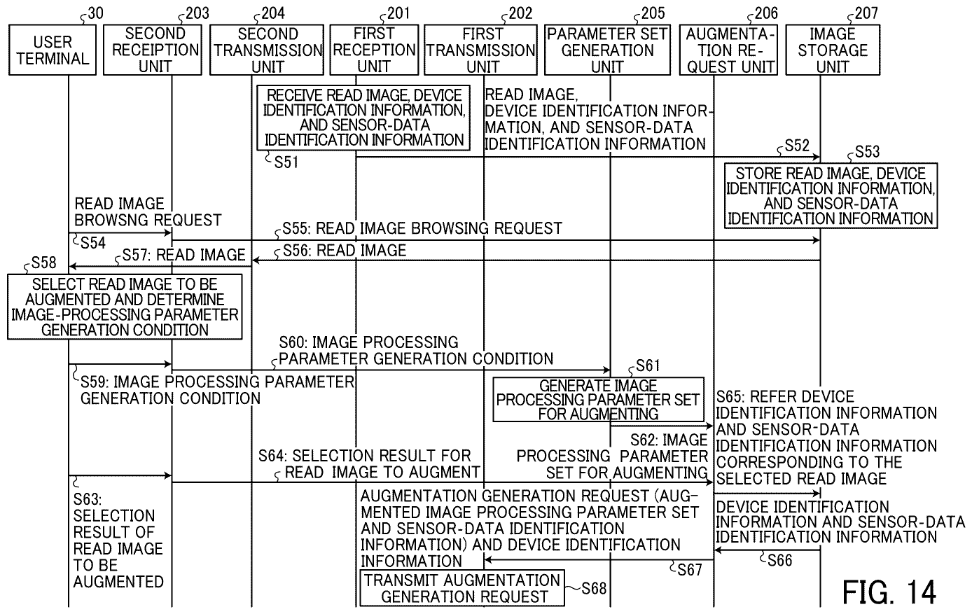

FIG. 14 is a sequence diagram illustrating an operation performed by the learning data server 20. A description is given of the flow of the operation performed by the learning data server 20 with reference to FIG. 14.

### <Step S51>

In step S51, the first reception unit 201 receives, from the image reading apparatus 10 via the network I/F 509, the read image generated by the image reading apparatus 10, the sensor-data identification information of the sensor data corresponding to the read image, and the device identification information for identifying the image reading apparatus 10.

### <Steps S52 and S53>

In steps S52 and S53, the first reception unit 201 stores the received read image, the sensor-data identification information, and the device identification information in the read image DB in the image storage unit 207 in association with each other.

### <Step S54>

In step S54, the user terminal 30 transmits a browsing request for the read image read by the image reading apparatus 10 to the learning data server 20 according to an operation by the learning data user.

### <Steps S55 and S56>

In step S55, the second reception unit 203 receives the request to view the read image. In step S56, the second reception unit 203 reads the read image from the read image DB of the image storage unit 207 and transmits the read image to the second transmission unit 204.

### <Step S57>

In step S57, the second transmission unit 204 transmits the read image read from the read image DB of the image storage unit 207 to the user terminal 30 via the network I/F 509. The user terminal 30 displays the read image received from the learning data server 20 on the display 508 of the user terminal 30.

### <Step S58>

In step S58, the learning data user selects a read image to be augmented from the list of read images displayed on the display 508 of the user terminal 30. The learning data user sets the image-processing parameter generation condition on the parameter condition setting screen 1000 displayed on the display 508 of the user terminal 30.

### <Step S59>

In step S59, the user terminal 30 transmits the image-processing parameter generation condition set on the parameter condition setting screen 1000 to the learning data server 20. The second reception unit 203 receives the image-processing parameter generation condition via the network I/F 509.

### <Step S60>

In step S60, the second reception unit 203 outputs the received image-processing parameter generation condition to the parameter set generation unit 205.

### <Steps S61 and S62>

In step S61, the parameter set generation unit 205 generates an augmented image processing parameter set based on the image-processing parameter generation condition received from the second transmission unit 204. In step S62, the parameter set generation unit 205 outputs the generated augmented image processing parameter set to the augmentation request unit 206.

### <Step S63>

In step S63, the user terminal 30 transmits a selection result of the read image to be augmented selected by the learning data user to the learning data server 20. The second reception unit 203 receives the selection result via the network I/F 509.

### <Step S64>

In step S64, the second reception unit 203 outputs the received selection result to the augmentation request unit 206.

### <Steps S65 and S66>

In step S65, the augmentation request unit 206 refers to the read image DB in the image storage unit 207. In step S66, the augmentation request unit 206 reads the device identification information and the sensor-data identification information corresponding to the read image indicated by the selection result received from the second reception unit 203.

### <Step S67>

The augmentation request unit 206 generates an augmentation generation request including the read sensor-data identification information and the augmented image processing parameter set received from the parameter set generation unit 205. The augmentation request unit 206 outputs the read device identification information and the generated augmentation generation request to the first transmission unit 202.

### <Step S68>

The first transmission unit 202 transmits the augmentation generation request received from the augmentation request unit 206 to the image reading apparatus 10 via the network I/F 509.

As described above, in the information processing system 1, the reading control unit 103 causes the reading sensor 633 to execute the reading operation on the document and acquires the sensor data read by the reading sensor 633. The storage unit 108 stores the sensor data and the sensor-data identification information for identifying the sensor data in association with each other. The image processing unit 106 generates the read image by the image processing using the predetermined image processing parameter for the sensor data. The transmission unit 101 transmits the read image to the learning data server 20. The first reception unit 201 receives the read image transmitted by the transmission unit 101. The parameter set generation unit 205 generates an augmented image processing parameter set for augmenting the read image selected by the user terminal 30 among the read images received by the first reception unit 201. The augmentation request unit 206 requests the image reading apparatus 10 to augment the read image by the augmented image processing parameter set and the sensor-data identification information corresponding to the read image selected by the user terminal 30. The image processing unit 106 reads the sensor data corresponding to the sensor-data identification information in the request from the storage unit 108. The image processing unit 106 generates the augmented read image by the image processing on the sensor data using the augmented image processing parameter set in the request in a case where the request is received. This can generate an augmented image that does not impair the read result without outputting the sensor data from the image reading apparatus to the outside.

The programs executed by the image reading apparatus 10 and the learning data server 20 may be provided by being incorporated in, e.g., a ROM in advance. The program executed by the image reading apparatus 10 and the learning data server 20 may be recorded in a computer-readable recording medium such as a compact disc-read-only memory (CD-ROM), a flexible disk (FD), a compact disc-recordable (CD-R), or a digital versatile disc (DVD) in a file of an installable format or an executable format and provided as a computer program product.

The programs executed by the image reading apparatus 10 and the learning data server 20 may be stored in a computer connected to a network such as the Internet and provided by being downloaded via the network. The programs executed by the image reading apparatus 10 and the learning data server 20 may be provided or distributed via a network such as the Internet.

The program executed by the image reading apparatus 10 and the learning data server 20 has a module configuration including the above-described functional units, and as actual hardware, the CPU (processor) reads the program from the ROM and executes the program, so that the above-described functional units are loaded on the main storage device and the functional units are generated on the main storage device.

Aspects of the present disclosure are as follows.

### Aspect 1

An image processing system includes one or more image processing apparatuses and a server apparatus communicably connected with the image processing apparatuses via a network. Each image processing apparatus includes apparatus circuitry configured to cause a reading sensor to read a document and acquire sensor data read by the reading sensor, store in a first memory the sensor data and first identification information for identifying the sensor data in association, generate a first read image by performing image processing on the sensor data using a predetermined image processing parameter, and transmit the first read image to the server apparatus. The server apparatus includes server circuitry configured to receive the first read images transmitted from the image processing apparatuses, generate a set of image processing parameters for augmenting a first read image, the first read image being selected by a user terminal from among the first read images received by the server circuitry, and request the image processing apparatus to augment the selected first read image by using the set of image processing parameters and the first identification information corresponding to the selected first read image. In response to reception of the request, the apparatus circuitry reads the sensor data corresponding to the first identification information in the request from the first memory, and generates a second read image by performing image processing on the sensor data using the set of image processing parameters in the request.

### Aspect 2

In the image processing system according to Aspect 1, the apparatus circuitry transmits the second read image to the server apparatus, and the server apparatus further stores the second read image in a second memory.

### Aspect 3

In the image processing system according to Aspect 1 or 2, the server circuitry generates the set of image processing parameters according to a condition for generating the image processing parameter determined by the user terminal.

### Aspect 4

In the image processing system according to any one of Aspects 1 to 3, the apparatus circuitry transmits the first identification information, the first read image indicated by the first identification information, and second identification information for identifying the image processing apparatus to the server apparatus. The server circuitry receives the first identification information, the first read image, and the second identification information each transmitted from the image processing apparatus, and requests the image processing apparatus identified by the second identification information for the second identification information corresponding to the first read image selected by the user terminal.

### Aspect 5

In the image processing system according to any one of Aspects 1 to 4, the second read image is used as learning data for machine learning.

### Aspect 6

In the image processing system according to any one of Aspects 1 to 5, the apparatus circuitry is configured to count, for each of the set of image processing parameters, the number of times the image processing parameter was used in generation of the first read image and determine the number of the second read images to be generated based on the counted number the image processing parameter is used.

### Aspect 7

In the image processing system according to Aspect 6, the apparatus circuitry adds a noise to the sensor data, the noise being similar to a noise generated in the reading operation by the reading sensor, and generate the determined number of second read images.

### Aspect 8

In the image processing system according to Aspect 1, the set of image processing parameters includes two or more image processing parameters having set in at least one of a minimum density setting area, a maximum density setting area, a color type setting area, a document type setting area, an automatic color adjustment setting area, a resolution setting area, a minimum zoom setting area, a maximum zoom setting area, or a zoom interval setting area.

### Aspect 9

An image processing apparatus includes circuitry configured to cause a reading sensor to read a document and acquire sensor data read by the reading sensor, store in a first memory the sensor data and first identification information for identifying the sensor data in association, generate a first read image by performing image processing on the sensor data using a predetermined image processing parameter, transmit the first read image to a server apparatus and receive, from the server apparatus, a request for augmenting the first read image selected by a user terminal by using a set of image processing parameters and the first identification information corresponding to the selected first read image. In response to reception of the request, the circuitry reads the sensor data corresponding to the first identification information in the request from the first memory, and generates a second read image by performing image processing on the sensor data using the set of image processing parameters in the request.

### Aspect 10

An image processing method includes, with a reading sensor, reading a document to acquire sensor data, storing in a first memory the sensor data and first identification information for identifying the sensor data in association, generating a first read image by performing image processing on the sensor data using a predetermined image processing parameter, transmitting the first read image to a server apparatus, and receiving, from the server apparatus, a request for augmenting the first read image selected by a user terminal by using a set of image processing parameters and the first identification information corresponding to the selected first read image. In response to reception of the request, the circuitry reads the sensor data corresponding to the first identification information in the request from the first memory, and generates a second read image by performing image processing on the sensor data using the set of image processing parameters in the request.

However, in the related art, it is not clear whether the sensor data is stored, and neither of the related art considers that the augmented image is generated without outputting the confidential information included in the sensor data to the outside.

Additionally, in the related art, image processing is not performed on sensor data but image processing is further performed on image data generated as a read image once. Accordingly, there is a problem that an augmented image different from a result of actual reading by the image reading apparatus is generated. For example, it is difficult to generate a color image from a monochrome image, or a gradation is different from an image actually read by the image reading apparatus due to a plurality of times of enlargement and reduction processing.

According to the present invention, it is possible to generate augmented data that does not impair a read result without outputting sensor data from an image processing apparatus to the outside.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processing system comprising:
one or more image processing apparatuses; and
a server apparatus communicably connected with the image processing apparatuses via a network,
each image processing apparatus including apparatus circuitry configured to:
cause a reading sensor to read a document and acquire sensor data read by the reading sensor;
store in a first memory the sensor data and first identification information for identifying the sensor data in association;
generate a first read image by performing image processing on the sensor data using a predetermined image processing parameter; and
transmit the first read image to the server apparatus,
the server apparatus including server circuitry configured to:
receive the first read images transmitted from the image processing apparatuses;
generate a set of image processing parameters for augmenting a first read image, the first read image being selected by a user terminal from among the first read images received by the server circuitry; and
request the image processing apparatus to augment the selected first read image by using the set of image processing parameters and the first identification information corresponding to the selected first read image,
wherein, in response to reception of the request, the apparatus circuitry reads the sensor data corresponding to the first identification information in the request from the first memory, and generates a second read image by performing image processing on the sensor data using the set of image processing parameters in the request.

2. The image processing system according to claim 1,
wherein the apparatus circuitry transmits the second read image to the server apparatus, and
wherein the server apparatus further stores the second read image in a second memory.

3. The image processing system according to claim 1,
wherein the server circuitry generates the set of image processing parameters according to a condition for generating the image processing parameter determined by the user terminal.

4. The image processing system according to claim 1, wherein
the apparatus circuitry transmits the first identification information, the first read image indicated by the first identification information, and second identification information for identifying the image processing apparatus to the server apparatus,
the server circuitry receives the first identification information, the first read image, and the second identification information each transmitted from the image processing apparatus, and
requests the image processing apparatus identified by the second identification information for the second identification information corresponding to the first read image selected by the user terminal.

5. The image processing system according to claim 1,
wherein the second read image is used as learning data for machine learning.

6. The image processing system according to claim 1,
wherein the apparatus circuitry is configured to:
count, for each of the set of image processing parameters, the number of times the image processing parameter was used in generation of the first read image; and
determine the number of the second read images to be generated based on the counted number the image processing parameter is used.

7. The image processing system according to claim 6,
wherein the apparatus circuitry adds a noise to the sensor data, the noise being similar to a noise generated in the reading operation by the reading sensor, and generate the determined number of second read images.

8. The image processing system according to claim 1,
wherein the set of image processing parameters includes two or more image processing parameters having set in at least one of a minimum density setting area, a maximum density setting area, a color type setting area, a document type setting area, an automatic color adjustment setting area, a resolution setting area, a minimum zoom setting area, a maximum zoom setting area, or a zoom interval setting area.

9. An image processing apparatus comprising circuitry configured to:
cause a reading sensor to read a document and acquire sensor data read by the reading sensor;
store in a first memory the sensor data and first identification information for identifying the sensor data in association;
generate a first read image by performing image processing on the sensor data using a predetermined image processing parameter;
transmit the first read image to a server apparatus; and
receive, from the server apparatus, a request for augmenting the first read image selected by a user terminal by using a set of image processing parameters and the first identification information corresponding to the selected first read image,
wherein, in response to reception of the request, the circuitry reads the sensor data corresponding to the first identification information in the request from the first memory, and generates a second read image by performing image processing on the sensor data using the set of image processing parameters in the request.

10. An image processing method comprising:
with a reading sensor, reading a document to acquire sensor data;
storing in a first memory the sensor data and first identification information for identifying the sensor data in association;
generating a first read image by performing image processing on the sensor data using a predetermined image processing parameter;
transmitting the first read image to a server apparatus; and
receiving, from the server apparatus, a request for augmenting the first read image selected by a user terminal by using a set of image processing parameters and the first identification information corresponding to the selected first read image,
wherein, in response to reception of the request, the circuitry reads the sensor data corresponding to the first identification information in the request from the first memory, and generates a second read image by performing image processing on the sensor data using the set of image processing parameters in the request.
